(19) United States
(12) Patent Application Publication
(10) Pub. No.: US 2009/0293698 A1
(43) Pub. Date: Dec. 3, 2009

(54) SAW BLADE HAVING TEETH WITH VARYING DEPTHS AND ALTERNATE TIP BEVELING

(75) Inventors: Nghiem Tran, Corona, CA (US); Hyok Lee, Corona, CA (US); Hi-Young Choi, Seoul (KR)

Correspondence Address: SNELL & WILMER LLP (OC), 600 ANTON BOULEVARD, SUITE 1400, COSTA MESA, CA, 92626, US

(73) Assignee: Corona Clipper, Inc., Corona, CA (US)

(21) Appl. No.: 12/130,842

(22) Filed: May 30, 2008

(51) Int. Cl. B27B 33/02

(52) U.S. Cl. 83/846; 83/697

(57) ABSTRACT

A saw blade for improved cutting efficiency includes teeth having depths and tip-to-tip spacings that vary as a function of distance from an end of the blade to the tooth, the teeth extending from the plane of the blade at alternating angles and having a recurring pattern of alternate tip beveling.

### BACKGROUND OF THE INVENTION

1. Field of the Invention

The present invention relates generally to saw blades. More specifically, the invention relates to a saw blade having teeth with varying depths and alternate tip beveling for improved cutting efficiency.

2. Description of Related Art

There are many types of saws and saw blades designed for home and industrial use throughout the world. The design of a particular saw depends on many factors, including its power source and the type of material that it is designed to cut. Whatever the application, a saw typically includes a blade that is made of a very hard metal such as steel. The blade will have a front or cutting edge and a back or non-cutting edge opposite the cutting edge. The cutting edge consists of a series of saw teeth, or serrations, and each tooth is bent at a specific angle known as the set. The set of a tooth is determined according to the application.

For example, in a crosscut saw, which is designed to cut wood at right angles to the direction of the grain, the cutting edge of each saw tooth is angled back and has a beveled edge for slicing through wood when the saw is pushed away from the sawyer (as in conventional Western blades) or pulled toward the sawyer (as in modern Asian blades). Because the Asian crosscut blade is designed to be pulled rather than pushed, the blade remains in tension while cutting. This prevents the blade from buckling and allows the blade to be made thinner, which reduces the kerf and the cutting energy.

The cutting edge of a crosscut saw may also use specialized teeth called cutters that project away from the blade at slight sideward angles. Other specialized saw teeth, called rakers, may be included on the serrated edge for scraping and stripping away wood from the kerf created by the cutters. Some ripsaws, which are designed to cut wood parallel to the direction of the grain, may have saw teeth that increase in depth along the length of the blade.

Over the years, many different tooth patterns have been developed for saw blades in an ongoing effort to improve the quality and efficiency of the cut. One of the more recent developments in saw blade technology is the so-called Mirai-Me (“future-tooth”) configuration shown as blade 10 in the front cross sectional view of FIG. 1. Each tooth 12 is formed from a gradual tapering of the blade from back 14 to tip 16 to achieve a final angle α with respect to the vertical centerline. As shown in FIG. 2, a raker or clearing tooth 18 may be provided at one end of the blade or at regular intervals along the cutting edge to clear wood strips and sawdust from clogging up the kerf. A magnified side view of the Mirai-Me pattern is shown in FIG. 3. Each tooth 12 has beveled edges 20 and 22 on its inside face and another inside-facing bevel 24 on its tip. Each tooth extends from the blade by a uniform tooth depth D.

### SUMMARY OF THE INVENTION

The present invention provides an improved saw blade that increases cutting efficiency by about 12%. The saw blade includes a blade plane and a row of teeth defining a cutting edge on the blade plane. The teeth of the saw blade may include one or more of the following features: tooth depths that vary as a function of blade length; tip-to-tip spacings between adjacent teeth that vary as a function of blade length; teeth extending from the blade plane at alternating angles of +α and −α; and teeth having a recurring pattern of alternate tip beveling.

The tooth depths or tip-to-tip spacings may vary linearly or non-linearly as a function of blade length, and the blade itself may be straight or arcuate. The saw blade with alternate tip beveling has a series of teeth with beveled tips, each tooth extending from the blade plane at an angle with respect to the blade plane wherein at least one of the tips is beveled on an outside surface and at least one of the tips is beveled on an inside surface. In one embodiment, the blade has a recurring pattern of tips with alternate tip beveling, for example, six tips beveled on an inside surface followed by two tips beveled on an outside surface. A saw blade according to the invention is preferably made from hardened steel, with impulse-hardened teeth, and has particular application as a pruning saw.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals designate like parts throughout the different views, wherein:

FIG. 1 is a front cross-sectional view of a prior art Mirai-Me saw blade.

FIG. 2 is a front cross-sectional view of a prior art Mirai-Me saw blade with clearing tooth.

FIG. 3 is a side view of the teeth of a prior art Mirai-Me saw blade.

FIG. 4 is a side view of one embodiment of a saw blade according to the invention.

FIG. 5 is a front cross sectional view of a saw blade according to the invention.

FIG. 6 is a magnified side view of the teeth of the saw blade of FIG. 4.

FIG. 7 is a magnified side view of a beveled tooth of the saw blade of FIG. 4, with the beveled edges and beveled tip facing inward.

FIG. 8 is a front view of the tooth of FIG. 7.

FIG. 9 is a top view of the tooth of FIG. 7.

FIG. 10 is a magnified side view of another beveled tooth of the saw blade of FIG. 4, with the beveled tip facing outward.

FIG. 11 is a front view of the tooth of FIG. 10.

FIG. 12 is a top view of the tooth of FIG. 10.

FIG. 13 is a perspective view of a test fixture for testing the cutting efficiency of a saw blade according to the invention.

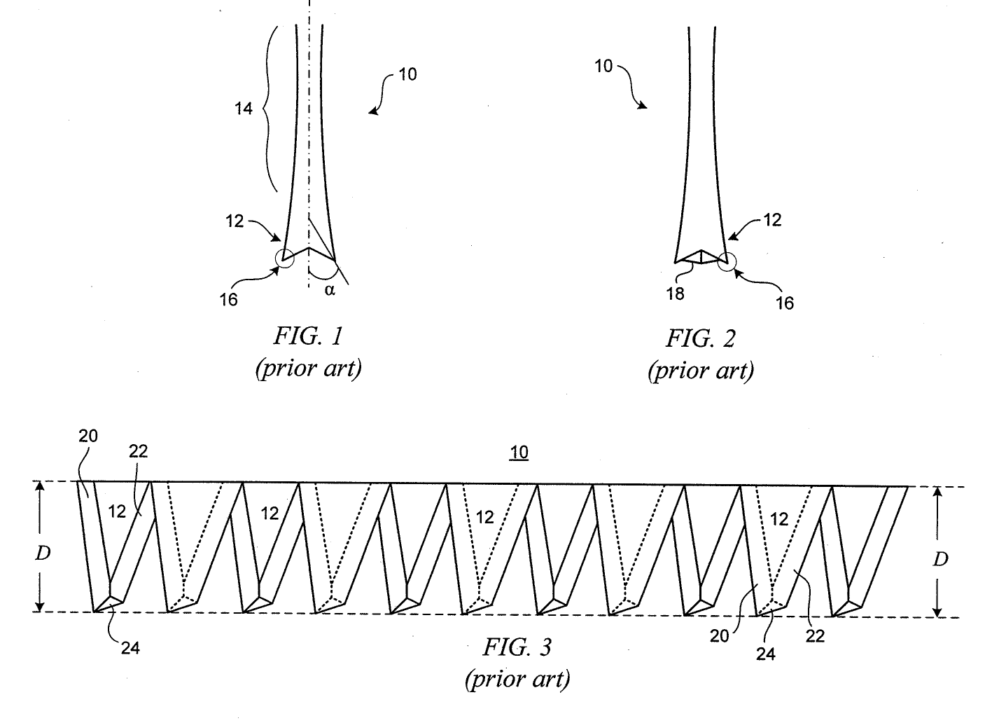

### DETAILED DESCRIPTION OF THE INVENTION

The following disclosure presents an exemplary embodiment of the invention for a saw blade that outperforms saw blades designed according to prior art. Specifically, a saw blade according to the invention provides significant improvement in cutting efficiency, as demonstrated by experimental testing conducted by the inventors. The results of the testing are presented herein following a physical description of a preferred embodiment of the invention.

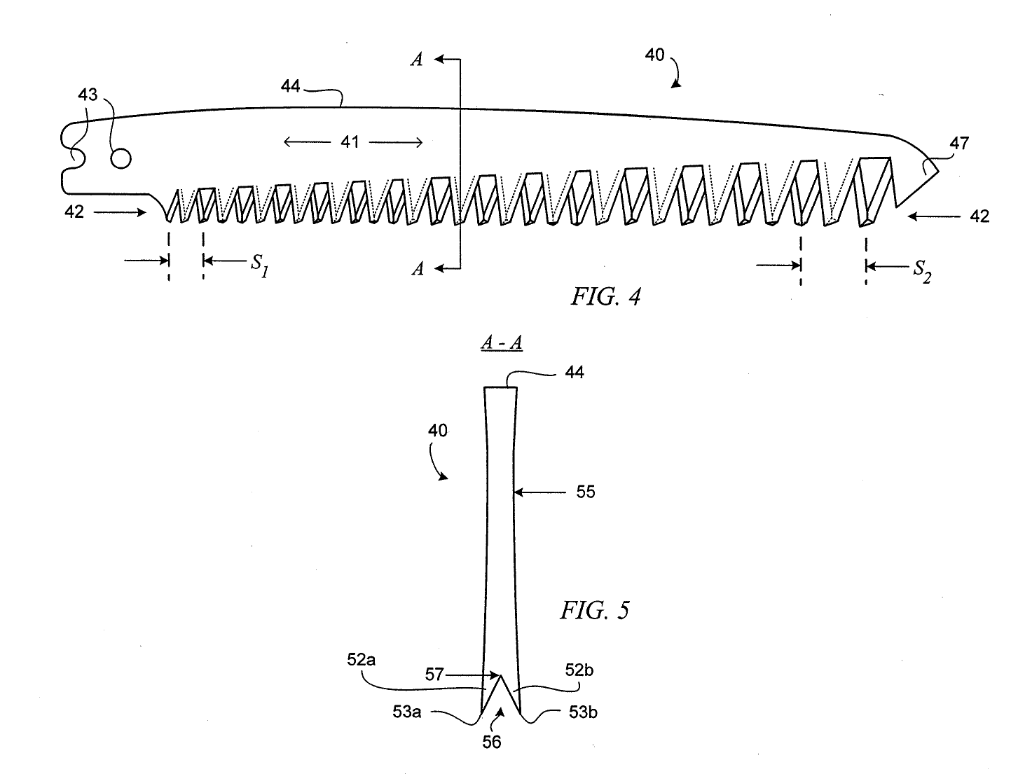

FIG. 4 shows a side view of one embodiment of a saw blade 40 according to the invention. Some of the features of the saw blade may be exaggerated in the figure for purposes of illustration, and so the drawing is not done to scale. In one embodiment, saw blade 40 has an overall length of about 346 mm, an overall height of about 44.5 mm, and a thickness of about 1.0 mm. Saw blade 40 is preferably formed by machining a plate of hardened carbon or stainless steel.

Generally, saw blade 40 includes an elongated blade plane 41 having a dull back portion 44 and a sharp row of teeth 42 that define a cutting edge on the blade plane opposite the back portion. Blade plane 41 has a heel at one end and a toe at the other end. At the heel end of the blade, there may be one or more slots or holes 43 formed in saw blade 40 for attaching the blade to a handle or other driving mechanism. In one embodiment, these holes or slots may have a diameter of about 8.0 mm. The toe end of the blade may be formed with an end tooth 47 for guiding the blade into a cut. End tooth 47 may have edges that are sharp or blunt, and may be offset some distance from the row of teeth 42. In one embodiment, the saw teeth are impulse-hardened.

The row of teeth 42 possess novel features that enhance the cutting efficiency of the saw blade. One of these features is a tip-to-tip distance that varies as the location for the measurement of that distance is moved along the cutting edge of the blade. A tip-to-tip distance defines the spacing between consecutive saw tooth tips that are set at the same angle from the cutting edge. The set angle will be described below in further detail.

In the embodiment shown in FIG. 4, the size of the teeth increase from heel to toe. This means that a minimum tip-to-tip distance S₁ occurs at or near the heel end of saw blade 40 and a maximum tip-to-tip distance S₂ occurs at or near the toe end of the saw blade, i.e., S₁<S₂. In one example, S₁ may have a value of about 7.50 mm and S₂ may have a value of about 9.00 mm. The increase in tip-to-tip distance according to the invention is a function of blade length, and is preferably a gradual increase. For example, in the case of a cutting edge that is straight or horizontal, the tip-to-tip distance may be defined according to a linear function of blade length.

In another embodiment (not shown), the size of the teeth increase from toe to heel, with a minimum tip-to-tip distance occurring at or near the toe end of saw blade 40 and a maximum tip-to-tip distance occurring at or near the heel end of the saw blade.

FIG. 5 is a front cross sectional view of the saw blade of FIG. 4 taken along the line A-A. This figure illustrates a preferred formation of saw teeth 52a and 52b by a smooth, gradual tapering of the saw blade 40 from back portion 44 to the respective tips 53a and 53b. In one embodiment, at the top of back portion 44 the nominal thickness of saw blade 40 is about 1.05 mm, tapering down to a nominal minimum thickness of about 0.95 mm at an intermediate location 55, and tapering up to a nominal tip-to-tip thickness of about 1.40 mm measured from tip 53a to tip 53b. The inner sides of each tooth 52a and 52b form a V-shaped notch 56. The apex 57 of the notch defines the base of each tooth.

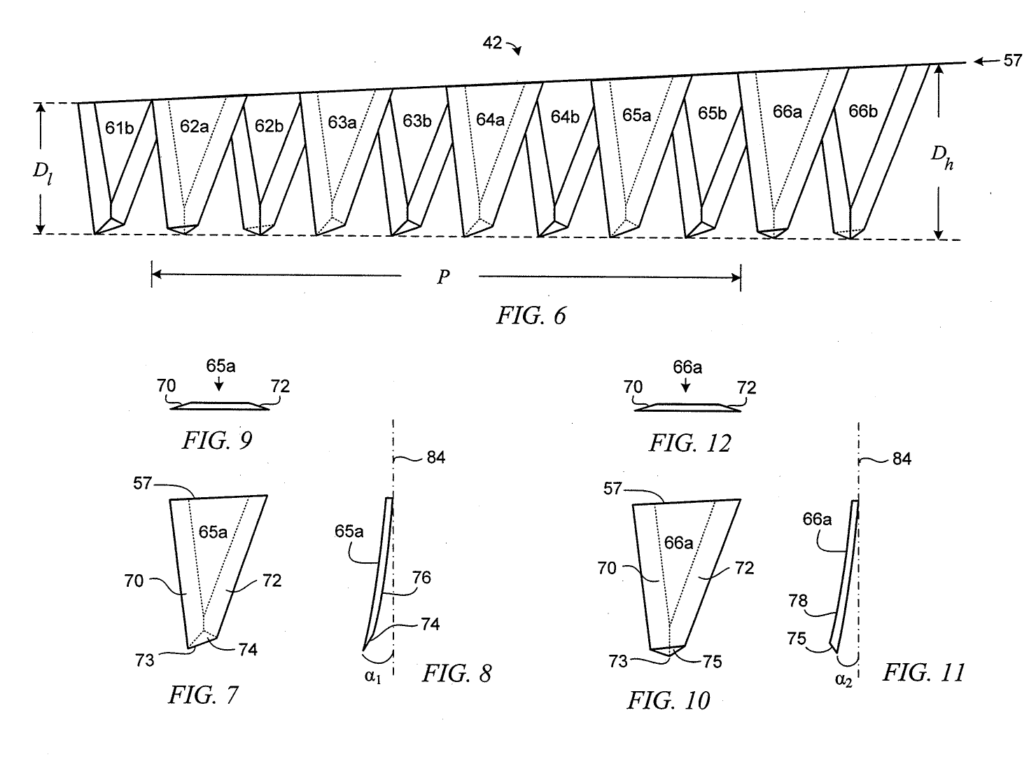

FIG. 6 illustrates a magnified side view of a segment of the row of teeth 42 of the saw blade 40. This view illustrates another novel feature of the invention, namely, saw tooth depths that vary as a function of distance from one end of the blade to the tooth. Saw tooth depth is the length of a straight line that extends vertically from the tip of a saw tooth to the base of the saw tooth (such as the double-arrowed line labeled Dₗ). In a preferred embodiment, the saw tooth depths increase in one direction along the length of the saw blade, as depicted in the figure. The saw tooth depths increase from left to right, with the lowest depth Dₗ occurring for the left-most saw tooth 61b, and with the highest depth Dₕ occurring for the right-most saw tooth 66b.

In one embodiment, the saw tooth depths increase linearly along the length of the blade. For example, along the entire length of saw blade 40, the tooth depth may range or gradually increase from a minimum depth of about Dₗ=3 mm to a maximum depth of about Dₕ=5 mm. The gradual increase may occur such that each intermediate tooth has a depth determined according to a formula for a straight line having a slope of approximately (Dₕ−Dₗ)/S_{c}, where S_{c} is the total length of the cutting edge. In this example, for a saw blade having a cutting edge length of about S_{c}=300 mm, the slope would be 1/150 mm, and the tip of each saw tooth would extend to the line defined by that slope. In another embodiment, the cutting edge of the saw blade may gradually increase linearly from a minimum depth of about Dₗ=3.75 mm to a maximum depth of about Dₕ=4.5 mm over a cutting edge length of about S_{c}=300 mm.

In other exemplary embodiments of the invention, the tooth depth may vary non-linearly along the cutting edge of the blade. For example, the tooth depths may increase according to a curve, conic, or hyperbolic shape. In other exemplary embodiments, the tooth depth may increase along a cutting edge, where the cutting edge itself may be curved or arcuate in shape, or where the entire blade plane may be curved or arcuate in shape. This may desirable for certain applications, such as a pruning saw. Many schemes for effecting a gradual variation in tooth depth are possible within the scope of the invention.

Another novel feature of the invention is illustrated in FIG. 6. This feature is known as alternate tip beveling. In alternate tip beveling, the saw blade includes at least one saw tooth that has its tip beveled on an outside surface and at least one saw tooth that has its tip beveled on an inside surface. In one embodiment, a saw blade according to the invention includes a series of beveled tips that exhibit alternate tip beveling. The alternate tip beveling may be provided as a recurring pattern along the cutting edge of the saw blade.

For example, FIG. 6 indicates one such recurring pattern P that repeats after every eight saw teeth. Saw teeth 62a, 62b, 66a, and 66b each have a tip that is beveled on an outside surface of the cutting edge, while saw teeth 61b, 63a, 63b, 64a, 64b, 65a, and 65b each have a tip that is beveled on an inside surface of the cutting edge. Beginning at tooth 62a, the pattern is: two saw teeth (62a, 62b) having outside surface tip beveling followed by six teeth (63a, 63b, 64a, 64b, 65a, 65b) having inside surface tip beveling. Other patterns for alternate tip beveling, whether recurring or non-recurring, are possible within the scope of the invention.

FIG. 7 and FIG. 8 provide side and front views, respectively, of saw tooth 65a in isolation to further illustrate the concept of alternate tip beveling. Saw tooth 65a has beveled edges 70 and 72 on its inside face (i.e. the surface facing away from the viewer) as indicated by the presence of the phantom lines. One or both of beveled edges 70 and 72 may extend for the entire depth of tooth 65a from the base 57 to the tip 73. Saw tooth 65a also includes a bevel 74 formed on the inside face of its tip 73. FIG. 9 shows a top view of saw tooth 65a.

In FIG. 8, the centerline 84 coincides with a plane defined by the blade plane 41 (FIG. 4). The tip 73 of saw tooth 65a is shown offset from centerline 84 by a set angle α₁, which is achieved by gradual tapering of the saw blade from back to tip. The location of bevel 74 is shown formed on the inside surface 76 of the saw tooth and facing toward the centerline. Thus, saw tooth 65a has inside surface tip beveling. Saw tooth 65b, which is adjacent to saw tooth 65a, also has inside surface beveling but extends from the centerline plane, or blade plane, at a set angle that points away from saw tooth 65a. In one embodiment, saw tooth 65a has a set angle of +α₁ and saw tooth 65b has a set angle of −α₁.

FIG. 10 and FIG. 11 provide side and front views, respectively, of saw tooth 66a in isolation to further illustrate the concept of alternate tip beveling. Saw tooth 66a has beveled edges 70 and 72 on its inside face, one or both of which may extend for the entire depth of tooth 66a from the base 57 to the tip 73. Saw tooth 66a also includes a bevel 75 formed on the outside face of its tip 73. FIG. 12 shows a top view of saw tooth 66a.

In FIG. 11, the centerline 84 coincides with a blade plane defined by the blade plane 41 (FIG. 4). The tip 73 of saw tooth 66a is shown offset from centerline 84 by a set angle α₂, which is achieved by gradual tapering of the saw blade from back to tip. The location of bevel 75 is shown formed on the outside surface 78 of the saw tooth and facing away from the centerline. Thus, saw tooth 66a has outside surface tip beveling. Saw tooth 66b, which is adjacent to saw tooth 66a, also has outside surface beveling but extends from the centerline plane at a set angle that points away from saw tooth 66a. In one embodiment, saw tooth 66a has a set angle of +α₁, and saw tooth 66b has a set angle of −α₁.

In a preferred embodiment, set angles α₁ and α₂ have the same value. It is also preferred to specify the set angles for any opposing pair of saw teeth to have the same value but opposite sign, e.g. +α and −α, relative to a zero-degree angle coincident with the centerline 84. Opposing pairs of saw teeth may be any two adjacent saw teeth having tips that taper or point in different directions (e.g. 63a and 63b comprise an opposing pair, 64a and 64b comprise another opposing pair, etc.).

With reference again to FIG. 4, one embodiment of a saw blade according to the invention includes a row of teeth 42 wherein substantially all of the teeth extend from the blade plane 41 at alternating angles of +α and −α with respect to the blade plane. Other embodiments according to the invention are possible where α₁ and α₂ have different absolute values. It is also possible within the scope of the invention to vary the set angles between a range of angular values, and to specify different set angles for each of any two opposing pairs of saw teeth.

Experimental Test

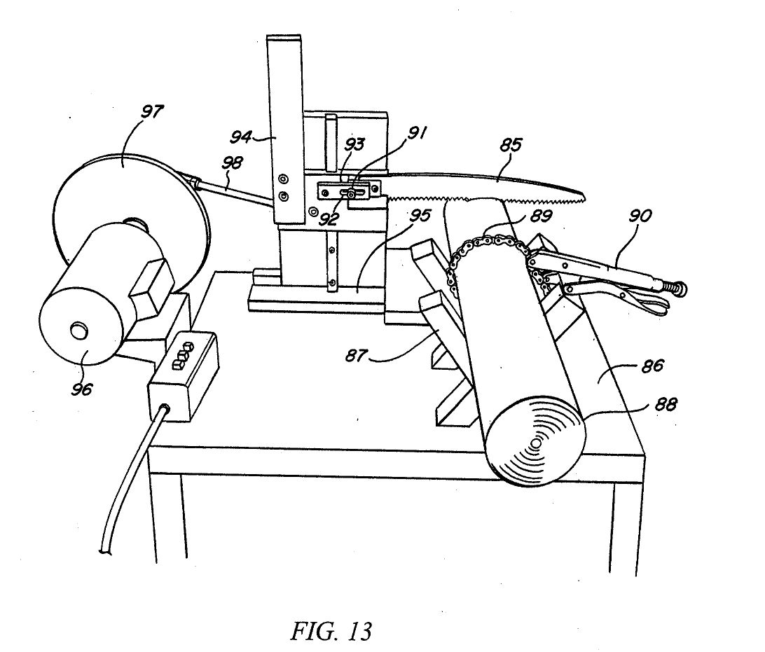

FIG. 13 depicts a test set-up used for testing the efficiency of a saw blade according to the invention. The experimental saw blade under test was a prototype similar in form to the embodiment shown in FIG. 4 and included the following features: (i) a row of teeth defining a cutting edge on a blade plane of hardened steel having tooth depths increasing as a function of the distance from the tow end of the blade to the tooth; (ii) the teeth extend from the blade plane at alternating angles with respect to the plane of +α and −α; (iii) the row of teeth having a recurring pattern of alternate tip beveling; and (iv) tip-to-tip spacing between adjacent teeth increasing as a function of the distance from the tow end of the blade to the tooth.

The saw blade under test (saw blade 85) and all test equipment were placed on a table 86 to provide a stable horizontal surface for conducting the test. A sturdy V-shaped rack 87 was placed on one side of table 86. A four-inch diameter log 88 was placed in the V-shaped rack 88. A chain 89 was wrapped around the log 88 and clamped to the V-shaped rack using a clamp 90 (vice grips) to immobilize the log.

Saw blade 85 was securely fixed to a bearing 91 that was clamped through a mounting hole in the saw blade and allowed to move horizontally within a slot 92 provided in a plate 93. The plate 93 was linked to a vertical guide structure 94 configured to allow the plate and saw to move downward to maintain the cutting edge of the saw blade against the log as the test progressed. The collective weight of plate 93 and hardware attached to plate 93 imparted a constant downward-acting force of 12.12 pounds on the saw blade. The vertical guide 94 was fixed to a bracket 95 that was bolted firmly to the surface of the test table.

An electric motor 96 was mounted to the table on the side opposite the log. A cam 97 was attached to the motor shaft, and a cam linkage 98 was linked between the bearing 91 and the cam 97 near the outer edge of the cam. With this arrangement, rotary motion of the motor was converted to linear motion of the cam linkage, causing saw blade 85 to reciprocate within slot 92 and draw the cutting edge of the saw blade back and forth across the log while under the constant weight of 12.12 pounds.

A control test was performed first using a blade from a Silky model NATANOKO60 300 LT, catalog no. 129-30, straight pruning saw. This model is not advertised as having a Mirai-Me blade, but does include tapered, non-set teeth similar in design to Mirai-Me and made by the same manufacturer. The motor was turned on, the blade was allowed to cut the log, and the number of strokes required to cut the log were counted. This test was repeated ten times. Then an experimental test was performed using the prototype saw blade according to the invention. The motor was turned on, the blade was allowed to cut the log, and the number of strokes required to cut the log were counted. This test was also repeated ten times. The same log was used for all tests. The results of these tests are tabulated below.

Test Results

| | Silky saw blade; | Prototype saw blade; |
|---|---|---|
| Test no. | No. of strokes | No. of strokes |
| 1 | 49 | 44 |
| 2 | 50 | 44 |
| 3 | 49 | 43 |
| 4 | 50 | 44 |
| 5 | 50 | 44 |
| 6 | 50 | 44 |
| 7 | 50 | 44 |
| 8 | 51 | 45 |
| 9 | 51 | 44 |
| 10 | 51 | 45 |

The data indicates that the prototype saw blade according to the invention provides greater cutting efficiency than the Silky saw blade. The average number of strokes required for the Silky blade to cut the log was 50.1. The average number of strokes required for the prototype blade to cut the log was 44.1. An average of six fewer strokes over a baseline of 50.1 translates to an improvement of about 12% in cutting efficiency.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that scope shall not be restricted, except in light of the appended claims and their equivalents.

What is claimed is:

1. A saw blade, comprising:
a blade plane having a toe end and a heel end; and
a row of teeth defining a cutting edge on the blade plane from the toe end to the heel end, with each tooth having a tooth depth that is a function of distance between the toe end and the tooth.

2. The saw blade of claim 1 wherein the tooth depths for the row of teeth increase linearly.

3. The saw blade of claim 1 wherein the tooth depths for the row of teeth gradually increase from a minimum of about 3 mm to a maximum of about 5 mm.

4. The saw blade of claim 1 wherein the tooth depths for the row of teeth gradually increase from a minimum of about 3.75 mm to a maximum of about 4.5 mm.

5. The saw blade of claim 1 wherein each tooth extends from the blade plane at an angle α with respect to the blade plane.

6. The saw blade of claim 5 wherein the teeth extend from the blade plane at alternating angles of +α and −α with respect to the blade plane.

7. The saw blade of claim 5 wherein one of the teeth has a tip beveled on an outside surface.

8. The saw blade of claim 7 wherein another one of the teeth has a tip beveled on an inside surface.

9. The saw blade of claim 1 wherein the row of teeth further comprises a series of beveled tips, wherein at least one of the tips is beveled on an outside surface and at least one of the tips is beveled on an inside surface.

10. The saw blade of claim 9 further comprising a recurring pattern of beveled tips, the pattern having tips beveled on an outside surface and tips beveled on an inside surface.

11. The saw blade of claim 10 wherein the recurring pattern consists of six tips beveled on an inside surface followed by two tips beveled on an outside surface.

12. The saw blade of claim 11 wherein the two tips beveled on an outside surface extend from the blade plane at angles of +α and −α with respect to the blade plane.

13. The saw blade of claim 1 wherein tip-to-tip spacing between adjacent teeth increases as a function of blade length.

14. A saw blade, comprising:
a blade plane having a toe end; and
a row of teeth defining a cutting edge on the blade plane;
each tooth in the row of teeth having a depth and a tip, each tooth depth and each tip-to-tip spacing between adjacent teeth being a function of distance between the toe end and the tooth;
wherein the teeth extend from the blade plane at alternating angles of +α and −α with respect to the blade plane.

15. The saw blade of claim 14 wherein the row of teeth further comprises a series of beveled tips, wherein at least one of the tips is beveled on an outside surface and at least one of the tips is beveled on an inside surface.

16. The saw blade of claim 15 further comprising a recurring pattern of beveled tips, the pattern having tips beveled on an outside surface and tips beveled on an inside surface.

17. The saw blade of claim 16 wherein the recurring pattern consists of six tips beveled on an inside surface followed by two tips beveled on an outside surface.

18. The saw blade of claim 14 on pruning saw.

19. The saw blade of claim 19 having an arcuate blade plane.

20. A saw blade comprising:
a blade plane having a toe end; and
a row of teeth having tooth depths and tip-to-tip spacings that vary as a function of distance from the toe end to the tooth, the teeth extending from the blade plane at alternating angles and having a recurring pattern of alternate tip beveling.
